(19) United States
(12) Patent Application Publication
(10) Pub. No.: US 2014/0295046 A1
(43) Pub. Date: Oct. 2, 2014

(54) EMULSIONS COMPRISING CAROTENOID FOR TRANSPARENT AND PASTEURIZATION-STABLE LIQUID FORMULATIONS, ESPECIALLY BEVERAGES

(71) Applicants: Gabriela Badolato Bönisch, Basel (CH); Hansjoerg Grass, Basel (CH)

(72) Inventors: Gabriela Badolato Bönisch, Basel (CH); Hansjoerg Grass, Basel (CH)

(73) Assignee: DSM IP ASSETS B.V., Heerlen (NL)

(21) Appl. No.: 14/236,538

(22) PCT Filed: Aug. 10, 2012
(86) PCT No.: PCT/EP2012/065652

§ 371 Date: May 2, 2014

(30) Foreign Application Priority Data
Aug. 11, 2011 (EP) 11177316.4

(51) Int. Cl. A23L 2/58

(52) U.S. Cl. CPC A23L 2/58
USPC 426/540; 426/602; 426/546; 426/590

(57) ABSTRACT

The present invention to stable carotenoid emulsions, which—when used in a liquid formulation (especially a beverage, such as a soft drink)—allows to obtain transparent formulation (even after pasteurization).

The present invention relates to stable emulsions comprising at least one carotenoid, which —when used in liquid formulations (especially beverages, such as soft drinks)—allows to obtain transparent formulations (even after pasteurization).

Carotenoids can be used as colorants. The carotenoids can be obtained from a natural source, by fermentation or by chemical synthesis.

The use of carotenoid(s) in liquid formulations is well known. But to provide an emulsion comprising at least one carotenoid, which allows to prepare a clear (non-turbid, non-opaque) and pasteurization-stable formulation (especially beverages, such as soft drinks) is not yet achieved in a satisfying manner.

Usually after the pasteurization step such formulations are getting very turbid, so that they are not transparent anymore.

For the use in many liquid formulations, such as beverages (i.e. soft drinks), a transparent form is desired for marketing reasons.

Therefore the goal of the present invention was to find an emulsion, which does not have the above mentioned disadvantages.

The usual process for producing liquid formulations (i.e. soft drinks) is that the carotenoid is emulsified in a first step. Afterwards this emulsion is incorporated into a liquid formulation.

Surprisingly, it has been found that when the carotenoid is emulsified with a specific emulsifier system an emulsion is obtained, which can be used in liquid (aqueous) formulations, which are then pasteurization-stable and transparent (after pasteurization).

Therefore the present application relates to an emulsion comprising
0.5 to 8 weight-% (wt-%), based on the total weight of the emulsion, of at least one carotenoid, and
3 to 57 wt-%, based on the total weight of the emulsion, of an emulsifier mixture, and
1 to 16 wt-%, based on the total weight of the emulsion, of at least one oil, and
0 to 1 wt-%, based on the total weight of the emulsion, of at least one antioxidant, and
18 to 95.5 wt-%, based on the total weight of the emulsion, of water,

characterized in that the mixture of emulsifiers comprises
(a) at least one polyoxyethylene sorbitan monofatty acid ester (=emulsifier (a)) and
(b) at least one emulsifier (no polyoxyethylene sorbitan monofatty acid ester) having a HLB value of at least 6 (preferably at least 6.5, more preferably at least 7) (=emulsifier (b)),

and wherein
(i) the ratio of carotenoid:polyoxyethylene sorbitan monofatty acid ester is 1:5 to 1:6.5 and
(ii) at least one other emulsifier (b) is present in an amount of 0.5 to 5 wt-%, based on the total weight of the emulsion, and
(iii) the amount of the least one emulsifier (a) is at least 4 times higher that the amount of the least one emulsifier (b).

All the percentages are always add up to 100. This requirements obviously applies for all the emulsions, formulations and mixture in the present patent application.

The term “carotenoid” as used herein comprises a natural or synthetic carotene or structurally related polyene compound which can be used as a functional health ingredient or colorant for food, such as α- or β-carotene, 8′-apo-β-carotenal, 8′-apo-β-carotenoic acid esters such as the ethyl ester, canthaxanthin, astaxanthin, lycopene, lutein, zeaxanthin or crocetin, or mixtures thereof. The preferred carotenoids are β-carotene, 8′-apo-β-carotenal, lycopene and lutein and mixtures thereof, especially β-carotene and 8′-apo-β-carotenal, most preferably 8′-apo-β-carotenal.
Therefore a preferred embodiment of the present invention relates to an emulsion as described above, wherein at least one carotenoid is chosen from the group consisting of α-carotene, β-carotene, 8′-apo-β-carotenal, 8′-apo-β-carotenoic acid esters such as the ethyl ester, canthaxanthin, astaxanthin, lycopene, lutein, zeaxanthin and crocetin, preferably β-carotene and 8′-apo-β-carotenal, most preferably 8′-apo-β-carotenal.

An emulsion according to the present invention comprises 0.5 to 8 wt-%, based on the total weight of the emulsion, of at least one carotenoid. A preferred emulsion comprises 0.5 to 5 wt-%, more preferred 1 to 5 wt-%, especially preferred 1.5 to 4 wt-%, based on the total weight of the emulsion, of at least one carotenoid.

An emulsion according to the present invention comprises 3 to 57 wt-%, based on the total weight of the emulsion, of an emulsifier mixture. A preferred emulsion comprises 3 to 37.5 wt-%, more preferred 5.5 to 37.5 wt-%, especially preferred 8 to 31 wt-%, based on the total weight of the emulsion, of an emulsifier mixture.

The emulsifier mixture used in an emulsion according to the present invention comprises at least two emulsifiers (at least one emulsifier (a) and at least one emulsifier (b)). At least one polyoxyethylene sorbitan monofatty acid ester is always part of the mixture (=emulsifier (a)). The other emulsifier (or emulsifiers) is at least another (not a polyoxyethylene sorbitan monofatty acid ester) emulsifier with a HLB of at least 6 (preferably at least 6.5, more preferably at least 7) (=emulsifier (b)).

Emulsifier (a): Preferably the polyoxyethylene sorbitan monofatty acid ester is chosen from the group consisting of polyoxyethylene(20) sorbitan monolaurate, polyoxyethylene(20) sorbitan-monopalmitate, polyoxyethylene(20) sorbitan monostearate and polyoxyethylene(20) sorbitan monooleate. These polyoxyethylene sorbitan monofatty acid esters are also known as Polysorbate 20 (Tween 20®), Polysorbate 40 (Tween 40®), Polysorbate 60 (Tween 60®) and Polysorbate 80 (Tween 80®). These compounds are available commercially.

The emulsifier (b) (or mixture of emulsifiers) having a HLB value of at least 6 (preferably at least 6.5, more preferably at least 7) is present in an amount of 0.5 to 5 wt-%, preferably, 1 to 4.5 wt-%, more preferably, 2 to 4.5 wt-%, based on the total weight of the emulsion.

Preferably the emulsifier having a HLB value of at least 6 (preferably at least 6.5, more preferably at least 7) is chosen from the group consisting of lecithin and polyglycerolesters of fatty acids.

The lecithin is usually a mixture of various phospholipids, whereas its composition depends on the origin of the lecithin. A major source of lecithin is i.e. soybean oil and sunflower oil.

The emulsifier mixture used in the emulsions according to the present invention comprises
(a) 80 to 98 wt-%, based on the total weight of the emulsifier mixture, of at least one polyoxyethylene sorbitan monofatty acid ester and
(b) 2 to 20 wt-%, based on the total weight of the emulsifier mixture, of at least one other (not a polyoxyethylene sorbitan monofatty acid ester) emulsifier with a HLB value of at least 6 (preferably at least 6.5, more preferably at least 7).

Preferably the emulsifier mixture comprises
(a) 80 to 98 wt-%, based on the total weight of the emulsifier mixture, of at least one polyoxyethylene sorbitan monofatty acid ester chosen from the group consisting of polyoxyethylene(20) sorbitan monolaurate, polyoxyethylene(20) sorbitanmonopalmitate, polyoxyethylene(20) sorbitan monostearate and polyoxyethylene(20) sorbitan monooleate and
(b) 2 to 20 wt-%, based on the total weight of the emulsifier mixture, of at least one emulsifier with a HLB value of at least 6 (preferably at least 6.5, more preferably at least 7) chosen from the group consisting of lecithin and polyglycerolesters of fatty acids.

An emulsion according to the present invention comprises at least one oil (one kind of oil or a mixture of oils).

The oils can be from any origin. They can be natural, modified or synthetic. If the oils are natural they can be plant or animal oils. Suitable oils are i.e. MCT (medium chain triglycerides), coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil or polyunsaturated fatty acids (such as triglyceride and/or ethyl ester (for example arachidonic acid, eicosapentaenoic acid, docosahexaenoic acid and y-linolenic acid and/or ethyl ester).

An emulsion according to the present invention comprises 1 to 16 wt-%, based on the total weight of the emulsion, of at least one oil. Preferably the emulsion comprises 1 to 10 wt-%, more preferred 2 to 10 wt-%, especially preferred 3 to 8 wt-%, based on the total weight of the emulsion, of at least one oil.

The emulsion can (optionally) contain at least one antioxidant, such as ascorbic acid or salts thereof, (synthetic or natural) tocopherol (i.e. dl-alpha-tocopherol); butylated hydroxytoluene (BHT); butylated hydroxyanisole (BHA); propyl gallate; tert. butyl hydroxyquinoline and/or ascorbic acid esters of a fatty acid). The preferred antioxidant is tocopherol (i.e. dl-alpha-tocopherol). When at least one antioxidant is used then in an amount of 0.01 to 1 wt-%, preferably 0.5 to 0.8 wt-%, based on the total weight of the emulsion.

Furthermore the emulsion can contain further ingredients such as ethoxyquin, plasticizers, preservatives (such as sorbic acid and its salts), stabilizers, acids (such as citric acid, acetic acid as well as their salts), humectants (such as glycerol, sorbitol, polyethylene glycol) protective colloids, dyes, fragrances, fillers and pH-buffers.

A preferred embodiment relates to an emulsion (I) comprising
0.5 to 8 wt-%, based on the total weight of the emulsion, of at least one carotenoid, chosen from the group consisting of α-carotene, β-carotene, 8′-apo-β-carotenal, 8′-apo-β-carotenoic acid esters, canthaxanthin, astaxanthin, lycopene, lutein, zeaxanthin and crocetin, (preferably β-carotene and 8′-apo-β-carotenal) and
3 to 57 wt-%, based on the total weight of the emulsion, of an emulsifier mixture, and
1 to 16 wt-%, based on the total weight of the emulsion, of at least one oil chosen from the group consisting of MCT, coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil and polyunsaturated fatty acids, and
0 to 1 wt-%, based on the total weight of the emulsion, of at least one antioxidant chosen from the group consisting of ascorbic acid, tocopherol, butylated hydroxytoluene (BHT), butylated hydroxyanisole (BHA), propyl gallate, tert. butyl hydroxyquinoline and ascorbic acid esters of a fatty acid, (preferably dl-alpha-tocopherol), and
18 to 95.5 wt-%, based on the total weight of the emulsion, of water,

characterized in that the mixture of emulsifiers comprises
(a) at least one polyoxyethylene sorbitan monofatty acid ester and
(b) at least one other emulsifier having a HLB value of at least 6 (preferably at least 6.5, more preferably at least 7),

and wherein
(i) the ratio of carotenoid:polyoxyethylene sorbitan monofatty acid ester is 1:5 to 1:6.5 and
(ii) the emulsifier (b) is present in amount of 0.5 to 5 wt-%, based on the total weight of the emulsion.

and wherein the mixture of emulsifiers comprises
(I) 80 to 98 wt-%, based on the total weight of the emulsifier mixture, of at least one polyoxyethylene sorbitan monofatty acid ester and
(II) 2 to 20 wt-%, based on the total weight of the emulsifier mixture, of at least one other (not a polyoxyethylene sorbitan monofatty acid ester) emulsifier with a HLB value of at least 6 (preferably at least 6.5, more preferably at least 7).

A preferred emulsion (I′) is emulsion (I), wherein the mixture of emulsifiers comprises
(I) 80 to 98 wt-%, based on the total weight of the emulsifier mixture, of at least one polyoxyethylene sorbitan monofatty acid ester chosen from the group consisting of polyoxyethylene(20) sorbitan monolaurate, polyoxyethylene(20) sorbitanmonopalmitate, polyoxyethylene(20) sorbitan monostearate and polyoxyethylene(20) sorbitan monooleate and
(II) 2 to 20 wt-%, based on the total weight of the emulsifier mixture, of at least one emulsifier with a HLB value of at least 6 (preferably at least 6.5, more preferably at least 7) chosen from the group consisting of lecithin and polyglycerolesters of fatty acids.

A more preferred embodiment relates to an emulsion (II) comprising
0.5 to 5 wt-%, based on the total weight of the emulsion, of at least one carotenoid, chosen from the group consisting of α-carotene, β-carotene, 8′-apo-β-carotenal, 8′-apo-β-carotenoic acid esters, canthaxanthin, astaxanthin, lycopene, lutein, zeaxanthin and crocetin, (preferably β-carotene and 8′-apo-β-carotenal) and
3 to 37.5 wt-%, based on the total weight of the emulsion, of an emulsifier mixture, and
1 to 10 wt-%, based on the total weight of the emulsion, of at least one oil chosen from the group consisting of MCT, coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil and polyunsaturated fatty acids, and
0 to 1 wt-%, based on the total weight of the emulsion, of at least one antioxidant chosen from the group consisting of ascorbic acid, tocopherol (preferred dl-alpha-tocopherol), butylated hydroxytoluene (BHT), butylated hydroxyanisole (BHA), propyl gallate, tert. butyl hydroxyquinoline and ascorbic acid esters of a fatty acid, (preferably dl-alpha-tocopherol), and
46.5 to 95.5 wt-%, based on the total weight of the emulsion, of water,

characterized in that

the mixture of emulsifiers comprises
(a) at least one polyoxyethylene sorbitan monofatty acid ester and (b) at least one other emulsifier having a HLB value of at least 6 (preferably at least 6.5, more preferably at least 7),

and wherein
(i) the ratio of carotenoid:polyoxyethylene sorbitan monofatty acid ester is 1:5 to 1:6.5 and
(ii) the emulsifier (b) is present in amount of 0.5 to 5 wt-%, based on the total weight of the emulsion,

and wherein the mixture of emulsifiers comprises
(I) 80 to 98 wt-%, based on the total weight of the emulsifier mixture, of at least one polyoxyethylene sorbitan monofatty acid ester and
(II) 2 to 20 wt-%, based on the total weight of the emulsifier mixture, of at least one other (not a polyoxyethylene sorbitan monofatty acid ester) emulsifier with a HLB value of at least 6 (preferably at least 6.5, more preferably at least 7).

A preferred emulsion (II′) is emulsion (II), wherein the mixture of emulsifiers comprises
(a) 80 to 98 wt-%, based on the total weight of the emulsifier mixture, of at least one polyoxyethylene sorbitan monofatty acid ester chosen from the group consisting of polyoxyethylene(20) sorbitan monolaurate, polyoxyethylene(20) sorbitanmonopalmitate, polyoxyethylene(20) sorbitan monostearate and polyoxyethylene(20) sorbitan monooleate and
(b) 2 to 20 wt-%, based on the total weight of the emulsifier mixture, of at least one emulsifier with a HLB value of at least 6 (preferably at least 6.5, more preferably at least 7) chosen from the group consisting of lecithin and polyglycerolesters of fatty acids.

An especially preferred embodiment relates to an emulsion (Ill) comprising
1 to 5 wt-%, based on the total weight of the emulsion, of at least one carotenoid, chosen from the group consisting of α-carotene, β-carotene, 8′-apo-β-carotenal, 8′-apo-β-carotenoic acid esters, canthaxanthin, astaxanthin, lycopene, lutein, zeaxanthin and crocetin, (preferably β-carotene and 8′-apo-β-carotenal) and
5.5 to 37.5 wt-%, based on the total weight of the emulsion, of an emulsifier mixture, and
2 to 10 wt-%, based on the total weight of the emulsion, of at least one oil chosen from the group consisting of MCT, coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil and polyunsaturated fatty acids, and
0 to 1 wt-%, based on the total weight of the emulsion, of at least one antioxidant chosen from the group consisting of ascorbic acid, tocopherol (synthetic or natural), butylated hydroxytoluene (BHT), butylated hydroxyanisole (BHA), propyl gallate, tert. butyl hydroxyquinoline and ascorbic acid esters of a fatty acid, (preferably dl-alpha-tocopherol), and
46.5 to 91.5 wt-%, based on the total weight of the emulsion, of water,

characterized in that the mixture of emulsifiers comprises
(a) at least one polyoxyethylene sorbitan monofatty acid ester and
(b) at least one other emulsifier having a HLB value of at least 6 (preferably at least 6.5, more preferably at least 7),

and wherein
(i) the ratio of carotenoid:polyoxyethylene sorbitan monofatty acid ester is 1:5 to 1:6.5 and
(ii) emulsifier (b) is present in amount of 0.5 to 5 wt-%, based on the total weight of the emulsion,

and wherein the mixture of emulsifiers comprises
(I) 80 to 98 wt-%, based on the total weight of the emulsifier mixture, of at least one polyoxyethylene sorbitan monofatty acid ester and
(II) 2 to 20 wt-%, based on the total weight of the emulsifier mixture, of at least one other (not a polyoxyethylene sorbitan monofatty acid ester) emulsifier with a HLB value of at least 6 (preferably at least 6.5, more preferably at least 7).

A preferred emulsion (III′) is emulsion (Ill), wherein the mixture of emulsifiers comprises
(a) 80 to 98 wt-%, based on the total weight of the emulsifier mixture, of at least one polyoxyethylene sorbitan monofatty acid ester chosen from the group consisting of polyoxyethylene(20) sorbitan monolaurate, polyoxyethylene(20) sorbitanmonopalmitate, polyoxyethylene(20) sorbitan monostearate and polyoxyethylene(20) sorbitan monooleate and
(b) 2 to 20 wt-%, based on the total weight of the emulsifier mixture, of at least one emulsifier with a HLB value of at least 6 (preferably at least 6.5, more preferably at least 7) chosen from the group consisting of lecithin and polyglycerolesters of fatty acids.

Most preferred embodiments relate to an emulsion (IV) comprising
1.5 to 4 wt-%, based on the total weight of the emulsion, of at least one carotenoid, chosen from the groups consisting of α-carotene, β-carotene, 8′-apo-β-carotenal, 8′-apo-β-carotenoic acid esters, canthaxanthin, astaxanthin, lycopene, lutein, zeaxanthin and crocetin, (preferably β-carotene and 8′-apo-β-carotenal) and
8 to 31 wt-%, based on the total weight of the emulsion, of an emulsifier mixture, and
3 to 8 wt-%, based on the total weight of the emulsion, of at least one oil chosen from the group consisting of MCT, coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil and polyunsaturated fatty acids, and
0 to 1 wt-%, based on the total weight of the emulsion, of at least one antioxidant chosen from the group consisting of ascorbic acid, tocopherol (synthetic or natural), butylated hydroxytoluene (BHT), butylated hydroxyanisole (BHA), propyl gallate, tert. butyl hydroxyquinoline and ascorbic acid esters of a fatty acid, (preferably dl-alpha-tocopherol), and
56 to 87.5 wt-%, based on the total weight of the emulsion, of water,

characterized in that

the mixture of emulsifiers comprises
(a) at least one polyoxyethylene sorbitan monofatty acid ester and
(b) at least one other emulsifier having a HLB value of at least 6 (preferably at least 6.5, more preferably at least 7),

and wherein
(i) the ratio of carotenoid:polyoxyethylene sorbitan monofatty acid ester is 1:5 to 1:6.5 and
(iii) emulsifier (b) is present in amount of 0.5-5 wt-%, based on the total weight of the emulsion,

and wherein the mixture of emulsifiers comprises
(I) 80 to 98 wt-%, based on the total weight of the emulsifier mixture, of at least one polyoxyethylene sorbitan monofatty acid ester and
(II) 2 to 20 wt-%, based on the total weight of the emulsifier mixture, of at least one other (not a polyoxyethylene sorbitan monofatty acid) emulsifier with a HLB value of at least 6 (preferably at least 6.5, more preferably at least 7).

Preferred emulsions (IV′) are emulsion (IV), wherein the mixture of emulsifiers comprises
(a) 80 to 98 wt-%, based on the total weight of the emulsifier mixture, of at least one polyoxyethylene sorbitan monofatty acid ester chosen from the group consisting of polyoxyethylene(20) sorbitan monolaurate, polyoxyethylene(20) sorbitanmonopalmitate, polyoxyethylene(20) sorbitan monostearate and polyoxyethylene(20) sorbitan monooleate and
(b) 2 to 20 wt-%, based on the total weight of the emulsifier mixture, of at least one emulsifier with a HLB value of 8 to 18 chosen from the group consisting of lecithin and polyglycerolesters of fatty acids.

The above disclosed and described emulsions are used in liquid formulations, such as beverages (especially soft drinks). The emulsions are usually used in such an amount that the total amount of the carotenoid compound(s) in the liquid formulations is 1 to 20 ppm.

Therefore a further embodiment of the present invention relates to the use of at least one emulsion comprising
0.5 to 8 wt-%, based on the total weight of the emulsion, of at least one carotenoid, and
3.0 to 57 wt-%, based on the total weight of the emulsion, of an emulsifier mixture, and
1 to 16 wt-%, based on the total weight of the emulsion, of at least one oil, and
0 to 1 wt-%, based on the total weight of the emulsion, of at least one antioxidant, and
18 to 95.5 wt-%, based on the total weight of the emulsion, of water,

characterized in that the mixture of emulsifiers comprises
(a) at least one polyoxyethylene sorbitan monofatty acid ester and
(b) at least one other emulsifier having a HLB value of at least 6 (preferably at least 6.5, more preferably at least 7),

and wherein
(i) the ratio of carotenoid:polyoxyethylene sorbitan monofatty acid ester is 1:5 to 1:6.5 and
(ii) the emulsifier (b) is present in amount of 0.5-5 wt-%, based on the total weight of the emulsion,

in a liquid formulation (preferably a beverage, such as a soft drink).

All preferences as described above for the emulsions apply to their use as well.

Preferred uses are those wherein emulsion (I), (I′), (II), (II′), (III), (III′), (IV) and/or (IV′) are used.

Furthermore the present invention also relates to liquid formulations (LF) comprising at least one emulsion comprising
0.5 to 8 wt-%, based on the total weight of the emulsion, of at least one carotenoid, and
3.0 to 57 wt-%, based on the total weight of the emulsion, of an emulsifier mixture, and
1 to 16 wt-%, based on the total weight of the emulsion, of at least one oil, and
0 to 1 wt-%, based on the total weight of the emulsion, of at least one antioxidant, and
18 to 95.5 wt-%, based on the total weight of the emulsion, of water,

characterized in that the mixture of emulsifiers comprises
(a) at least one polyoxyethylene sorbitan monofatty acid ester and
(b) at least one other emulsifier having a HLB value of at least 6 (preferably at least 6.5, more preferably at least 7),

and wherein
(i) the ratio of carotenoid:polyoxyethylene sorbitan monofatty acid ester is 1:5 to 1:6.5 and
(ii) the emulsifier (b) is present in amount of 0.5-5 wt-%, based on the total weight of the emulsion.

All preferences as described above for the emulsions apply to the liquid formulations as well.

Preferred liquid formulations are those comprising emulsion (I), (I′), (II), (II′), (III), (III′), (IV) and/or (IV′).

More preferred liquid formulations (LF′) are those comprising emulsion (I), (I′), (II), (II′), (III), (III′), (IV) and/or (IV′) and wherein the carotenoid content in LF′ is 1-20 ppm.

Preferred liquid formulations (LF″) are liquid formulations (LF) and (LF′), which is a beverage (preferably a soft drink).

Preferably, the beverage (preferably a soft drink) is clear and pasteurized.

The process of preparing these formulations is done according to well known processes. The process involves a pasteurization step after which the liquid transparent formulation is not getting turbid, even after some storage time.

Furthermore, due to the fact that the amount of polyoxyethylene sorbitan monofatty acid ester is reduced, an improved sensory of the soft drinks is achieved.

The turbidity of the liquid, transparent and non-pasteurized formulations and of the liquid, transparent pasteurized formulations comprising at least one of the above described emulsions is less than 10 NTU (for a 10 ppm carotenoid concentration).

The measurement of the turbidity is done by using standard methods (EN27027(ISO7027). All the measurements for this patent application are done by using a turbiditymeter Hach 2100N IS® from Hach Company, Loveland, Colo. (USA). The turbidity is given in nephelometric turbidity units (NTU). The measurement angle was 90°+−2.5° and the measurement wavelength was: 860 nm+−10 nm LED. The measurements were done at room temperature.

The following examples serve to illustrate the invention. All percentages and parts are related to weight and the temperature is given in degree Celsius, if not otherwise stated.

### EXAMPLES

In a first step the oil-in-water-emulsion is prepared. Examples 1a to 1c

### Emulsions Comprising Apocarotenal

All the emulsions (1a to 1c), which are listed in Table 1 are prepared according to the following procedure:

A mixture of medium-chain triglycerides (MCT) and dl-alpha-tocopherol was warmed up to 135° C. Apoacarotenal (crystal form) was added within 5 minutes to the mixture. The mixture was stirred for 10 minutes and a clear solution was obtained. The clear solution was then cooled down to 105° C. under stirring (solution 1).

In another vessel, a mixture of Tween 80 (Lamesorb SMO 20 from Cognis, Germany, HLB value 15) and Polyglycerolesters of fatty acids (Polyglycerol esters of fatty acid EREZ Z from Sharon Laboratories Ltd, Israel, HLB value 7) was warmed up to 60° C. under stirring.

Solution 1 (105° C.) was then added to the Tween 80/Polyglycerolesters of fatty acids mixture (60° C.) under stirring (solution 2). Solution 2 was poured into deionised water (60° C.) under stirring with Rotor/Stator emulsification system during 1 to 2 minutes at approx. 60° C. The emulsion was cooled down to room temperature under stirring.

TABLE 1a
Emulsions comprising apocarotenal

| | Exp. No. | | |
|---|---|---|---|
| Ingredients | 1a | 1b | 1c |
| Apocarotenal cryst. | 3.2% | 3.2% | 3.2% |
| dl-α-Tocopherol | 0.3% | 0.3% | 0.3% |
| MCT (Medium-chain triglyceride) | 7.5% | 7.5% | 7.5% |
| Tween 80 | 17.0% | 17.0% | 17.0% |
| Polyglycerolesters of fatty acids | 2.5% | 2.5% | 2.5% |
| Water | 69.5% | 68.9% | 68.8% |
| Citric acid | — | 0.6% | 0.6% |
| Potassium sorbate | — | — | 0.1% |

### Examples 2a to 2b

### Emulsions Comprising β-Carotene

All the emulsions (2a to 2b), which are listed in Table 2, are prepared according to the following procedure:

A mixture of medium-chain triglycerides (MCT) and dl-alpha-tocopherol was warmed up to 165° C. β-carotene (crystal form) was added within 5 minutes to the mixture. The mixture was stirred for 10 minutes and a clear solution was obtained. The clear solution was then cooled down to 105° C. under stirring (solution 1).

In another vessel, a mixture of Tween 80 (Lamesorb SMO 20 from Cognis, Germany, HLB value 15) and Polyglycerolesters of fatty acids (Polyglycerol esters of fatty acid EREZ Z from Sharon Laboratories Ltd, Israel, HLB value 7) was warmed up to 60° C. under stirring.

Solution 1 (105° C.) was then added to the Tween 80/Polyglycerolesters of fatty acids mixture (60° C.) under stirring (solution 2). Solution 2 was poured into deionised water (60° C.) under stirring with Rotor/Stator emulsification system during 1 to 2 minutes at approx. 60° C. The emulsion was cooled down to room temperature under stirring.

TABLE 2a
Emulsions comprising β-carotene

Exp. No.

| Ingredients | 2a | 2b |
|---|---|---|
| β-Carotene cryst. | 3.2% | 3.2% |
| dl-α-Tocopherol | 0.3% | 0.3% |
| MCT (Medium-chain triglyceride) | 7.5% | 7.5% |
| Tween 80 | 17.0% | 17.0% |
| Polyglycerolesters of fatty acids | 2.5% | 2.5% |
| Water | 68.9% | 69.15% |
| Citric acid | 0.6% | 0.25% |
| Potassium sorbate | — | 0.1% |

### Examples 3 and 4

### Formulations Examples

The following examples are those wherein the emulsions of the previous examples was used in a liquid formulation. In a first set of tests aqueous formulations were prepared and in second set of test beverage formulations were prepared.

For the following examples the two liquid aqueous formulations were produced. One wherein the content of the carotenoid compound was 5 ppm and a second one with a content of 10 ppm. All formulations were produced by adding the emulsion into water

The turbidity was measured after the preparation.

### Examples 3a to 3c′

### Liquid Formulations Comprising Emulsion 1a to 1c

TABLE 3a
Formulations comprising the emulsions of Example 1a and 1b

| | Example | | | | | | | |
|---|---|---|---|---|---|---|---|---|
| | 3a | | 3a′ | | 3b | | 3b′ | |
| | (emuls. 1a) | | (emuls. 1a) | | (emuls. 1b) | | (emuls. 1b) | |
| Apocarotenal | 5 | ppm | 10 | ppm | 5 | ppm | 10 | ppm |
| content | | | | | | | | |
| Turbidity | 0.8 | NTU | 1.4 | NTU | 0.7 | NTU | 1.5 | NTU |

TABLE 3b
Formulations comprising the emulsions of Example 1c

| Example | | |
|---|---|---|
| | 3c | 3c′ |
| | (emuls. 1c) | (emuls. 1c) |

| | | | | |
|---|---|---|---|---|
| Apocarotenal content | 5 | ppm | 10 | ppm |
| Turbidity | 0.8 | NTU | 1.6 | NTU |

### Examples 4a to 4b′

### Liquid Formulations Comprising Emulsion 2a to 2b

TABLE 4a
Formulations comprising the emulsions of Example 2a and 2b

| | Example | | | | | | | |
|---|---|---|---|---|---|---|---|---|
| | 4a | | 4a′ | | 4b | | 4b′ | |
| | (emuls. 2a) | | (emuls. 2a) | | (emuls. 2b) | | (emuls. 2b) | |
| β-carotene | 5 | ppm | 10 | ppm | 5 | ppm | 10 | ppm |
| content | | | | | | | | |
| Turbidity | 1.0 | NTU | 1.8 | NTU | 1.0 | NTU | 2.0 | NTU |

### Example 5

### Soft Drinks Formulations (Carotenoid Content 10 ppm)

The emulsions of Example 1 and 2 were also incorporated into a soft drink formulation.

The soft drink formulation for all the following examples is listed in table 5:

TABLE 5
Soft drink formulations

| Ingredients | g |
|---|---|
| Potassium sorbate | 0.2 |
| Sugar syrup (64° Brix) | 156.2 |
| Ascorbic acid | 0.2 |
| Citric acid 50% w/w | 5.0 |
| Apricot flavour (water soluble, Givaudan 78848-56) | 0.2 |
| Emulsions of Examples 1 or 2 | 0.313 |
| Drink water | to 1000 g |

The formulations comprising the emulsion were prepared in the following way:
Dissolve potassium sorbate in water.
Add sugar syrup, ascorbic acid, citric acid, flavour, and the emulsion of example 1 or 2 one after the other while stirring gently. It is advantageous to dilute the emulsion before adding.

Pasteurization:

Pasteurization of the soft drink formulation was conducted in a bath of water. The bottles (glass bottles/200 ml) were placed in an 85° C. water bath. After reaching 80° C., samples remained in the water bath for 1 additional minute. A reference bottle containing water and a thermometer was used for the control of the temperature during pasteurization. After pasteurization bottles are quickly cooled (using cold water) to room temperature.

The turbidity was measured by using a turbiditymeter Hach 2100N IS® from Hach Company, Loveland, Colo. (USA). The turbidity is given in nephelometric turbidity units (NTU). The measurement angle was 90°+−2.5° and the measurement wavelength was: 860 nm+−10 nm LED. The measurements were done at room temperature.

TABLE 6
Turbidity of the soft drink formulations comprising
emulsions 1a to 2b (carotenoid content 10 ppm)

| | Example | | | | |
|---|---|---|---|---|---|
| | 5a | 5b | 5c | 5d | 5e |
| | (emul. | (emul. | (emul. | (emul. | (emul. |
| | 1a) | 1b) | 1c) | 2a) | 2b) |
| Turbidity [NTU] | 3.1 | 2.6 | 2.9 | 2.6 | 2.6 |
| non-past. | | | | | |
| Turbidity [NTU] | 1.9 | 1.9 | 1.9 | 2.4 | 2.5 |
| past. | | | | | |
| Turbidity [NTU] | 3.8 | 3.5 | 3.5 | 2.4 | 2.3 |
| non-past. | | | | | |
| after 1 month | | | | | |
| Turbidity [NTU] | 2.8 | 3.4 | 3.3 | 2.7 | 2.5 |
| past. | | | | | |
| after 1 month | | | | | |
| Turbidity [NTU] | 5.5 | 5.4 | 5.7 | 2.8 | 2.7 |
| non-past. | | | | | |
| after 3 months | | | | | |
| Turbidity [NTU] | 4.1 | 5.1 | 4.9 | 2.9 | 2.7 |
| past. | | | | | |
| after 3 months | | | | | |

All the soft drink formulations comprising the emulsions according to the present invention showed very low turbidity.

### Example 6

### Comparative Example with Apocarotenal

To demonstrate the inventive step of the present invention similar emulsions (but without emulsifier mixture) were prepared and tested.

The soft drink formulation used is the same as listed in table 5.

TABLE 7
Emulsions comprising apocarotenal and
no polyglycerolesters of fatty acids

Exp. No.

| Ingredients | 6 | 6a |
|---|---|---|
| Apocarotenal cryst. | 3.2% | 3.2% |
| dl-α-Tocopherol | 0.3% | 0.3% |
| MCT (Medium-chain triglyceride) | 7.5% | 7.5% |
| Tween 80 | 17.0% | 19.5% |
| Polyglycerolesters of fatty acids | — | — |
| Water | 72.0% | 68.9% |
| Citric acid | — | 0.6% |

TABLE 8
Turbidity of the soft drink formulations comprising
emulsion 6 (carotenoid content 10 ppm) emulsion
6a (carotenoid content 10 ppm)

Example

| | 7 | 7a |
|---|---|---|
| | (emul. 6) | (emul. 6a) |
| Turbidity [NTU] | 4.7 | 6.4 |
| non-past. | | |
| Turbidity [NTU] | 18.6 | 11.0 |
| past. | | |
| Turbidity [NTU] | 4.4 | 7.5 |
| non-past. | | |
| after 1 month | | |
| Turbidity [NTU] | 6.3 | 9.6 |
| non-past. | | |
| after 3 months | | |
| Turbidity [NTU] | 21.5 | 14.7 |
| past. | | |
| after 1 month | | |
| Turbidity [NTU] | 30.8 | 17.6 |
| past. | | |
| after 3 months | | |

It can be seen that the turbidity (especially after the pasteurization) is significantly higher in comparison to the soft drinks comprising the emulsion of the present invention.

### Example 7

### Comparative Example with β-Carotene

To demonstrate the inventive step of the present invention similar emulsions (but without emulsifier mixture) were prepared and tested.

The soft drink formulation used is the same as listed in table 5.

TABLE 9
Emulsions comprising β-carotene and
no polyglycerolesters of fatty acids

| | Exp. No. |
|---|---|
| Ingredients | 7 |
| β-carotene | 3.2% |
| dl-α-Tocopherol | 0.3% |
| MCT (Medium-chain triglyceride) | 7.5% |
| Tween 80 | 17.0% |
| Polyglycerolesters of fatty acids | — |
| Water | 72.0% |

TABLE 10
Turbidity of the soft drink formulations comprising
emulsion 7 (carotenoid content 10 ppm)

| | Example |
|---|---|
| | 8 (emul. 7) |
| Turbidity [NTU] | 6.1 |
| non-past. | |
| Turbidity [NTU] | 17.9 |
| past. | |
| Turbidity [NTU] | 4.8 |
| non-past. | |
| after 1 month | |
| Turbidity [NTU] | 5.9 |
| non-past. | |
| after 3 months | |
| Turbidity [NTU] | 20.7 |
| past. | |
| after 1 month | |
| Turbidity [NTU] | 20.2 |
| past. | |
| after 3 months | |

It can be seen that the turbidity (especially after the pasteurization) is significantly higher in comparison to the soft drinks comprising the emulsions of the present invention.

1. An emulsion comprising
0.5 to 8 wt-%, based on the total weight of the emulsion, of at least one carotenoid, and
3 to 57 wt-%, based on the total weight of the emulsion, of an emulsifier mixture, and
1 to 16 wt-%, based on the total weight of the emulsion, of at least one oil, and
0 to 1 wt-%, based on the total weight of the emulsion, of at least one antioxidant, and
18 to 95.5 wt-%, based on the total weight of the emulsion, water,
characterized in that the mixture of emulsifiers comprises
(a) at least one polyoxyethylene sorbitan monofatty acid ester and
(b) at least one emulsifier having a HLB value of at least 6 (preferably at least
6.5, more preferably at least 7),
and wherein
(i) the ratio of carotenoid:polyoxyethylene sorbitan monofatty acid ester is 1:5 to 1:6.5 and
(ii) at least one emulsifier (b) is present in amount of 0.5 to 5 wt-%, based on the total weight of the emulsion, and
(iii) the amount of the least one emulsifier (a) is at least 4 times higher that the amount of the least one emulsifier (b).

2. An emulsion according to claim 1, wherein the carotenoid is chosen from the group consisting of α-carotene, β-carotene, 8′-apo-β-carotenal, 8′-apo-β-carotenoic acid esters, canthaxanthin, astaxanthin, lycopene, lutein, zeaxanthin and crocetin, preferably β-carotene, 8′-apo-β-carotenal and 8′-apo-β-carotenoic acid esters.

3. An emulsion according to claim 1, wherein the emulsion comprises 0.5 to 5 wt-%, based on the total weight of the emulsion, of at least one carotenoid.

4. An emulsion according to claim 1, wherein the emulsion comprises 3 to 37.5 wt-%, based on the total weight of the emulsion, of an emulsifier mixture.

5. An emulsion according to claim 1, wherein the polyoxyethylene sorbitan monofatty acid of the emulsifier mixture is chosen from the group consisting of polyoxyethylene(20) sorbitan monolaurate, polyoxyethylene(20) sorbitan-monopalmitate, polyoxyethylene(20) sorbitan monostearate and polyoxyethylene(20) sorbitan monooleate.

6. An emulsion according to claim 1, wherein the emulsifier having a HLB value of at least 6 (preferably at least 6.5, more preferably at least 7) of the emulsifier mixture is chosen from the group consisting of lecithin and polyglycerolesters of fatty acids.

7. An emulsion according to claim 1, wherein the emulsifier mixture comprises
(a) 80 to 98 wt-%, based on the total weight of the emulsifier mixture, of at least one polyoxyethylene sorbitan monofatty acid ester and
(b) 2 to 20 wt-%, based on the total weight of the emulsifier mixture, of at least one other emulsifier with a HLB value of at least 6 (preferably at least 6.5, more preferably at least 7).

8. An emulsion according to claim 1, wherein the emulsion comprises 1 to 10 wt-%, based on the total weight of the emulsion, of at least one oil.

9. An emulsion according to claim 1, wherein the oil is chosen from the group consisting of MCT, coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil and polyunsaturated fatty acids.

10. An emulsion according to claim 1, comprising 0.01 to 1 wt-%, preferably 0.5 to 0.8 wt-%, based on the total weight of the emulsion, of at least one antioxidant chosen from the group consisting of ascorbic acid or salts thereof, (synthetic or natural) tocopherol (dl-alpha-tocopherol), butylated hydroxytoluene (BHT), butylated hydroxyanisole (BHA), propyl gallate, tert. butyl hydroxyquinoline and ascorbic acid esters of a fatty acid.

11. An emulsion according to claim 1, comprising further ingredients such as ethoxyquin, plasticizers, preservatives (such as sorbic acid and its salts), stabilizers, acids (such as citric acid, acetic acid as well as their salts), humectants (such as glycerol, sorbitol, polyethylene glycol) protective colloids, dyes, fragrances, fillers and pH-buffers.

12. Use of at least one emulsion according to claim 1 in a liquid formulation (preferably a beverage).

13. Use according to claim 12, wherein the liquid formulation is clear and pasteurized.

14. Liquid formulation (preferably beverages) comprising at least one emulsion according to claim 1.

15. Liquid formulation according to claim 14, which is clear and pasteurized.

16. Liquid formulation according to claim 14, wherein the carotenoid content is 1-20 ppm.
